(19) United States
(12) Patent Application Publication
(10) Pub. No.: US 2019/0164152 A1
(43) Pub. Date: May 30, 2019

(54) PHYSICAL COMMODITY-BASED CURRENCY SYSTEM

(71) Applicant: Mathias Bucher, Feusisberg (CH)

(72) Inventor: Mathias Bucher, Feusisberg (CH)

(21) Appl. No.: 16/198,764

(22) Filed: Nov. 22, 2018

Related U.S. Application Data
(60) Provisional application No. 62/590,389, filed on Nov. 24, 2017.

(51) Int. Cl. G06Q 20/38; G06Q 20/40; G06Q 40/08

(52) U.S. Cl. CPC G06Q 20/381; G06Q 40/08; G06Q 20/40; G06Q 20/389

(57) ABSTRACT

A system for determining a total denomination value for one or more currency objects that are to be based on an instance of a commodity item type whose price is affected by a plurality of physical attributes. In a preferred embodiment the commodity item type is polished diamonds and the currency objects are cryptocurrency tokens.

This application claims the benefit of priority to U.S. provisional patent application 62/590,389 filed on Nov. 24, 2017 for which the benefit of priority is claimed here and the full contents of which are hereby incorporated by reference.

### TECHNICAL FIELD

The present invention is in the field of currency. More specifically the field of physical commodity-based currency systems.

### DISCLOSURE OF THE INVENTION

As used herein the term currency refers to a transferable object that may be accepted as payment for goods and services and repayment of debts between parties. Most currency objects today are fiat currencies. A currency object may be a tangible physical object, or be an intangible object existing as stored information.

A fiat currency object, like a paper currency bill, is without useful value itself as a commodity. The fiat currency object derives its value by being declared by the governing authority of a jurisdiction to be legal tender in that jurisdiction; that is, the fiat currency object must be accepted as a form of payment within the jurisdiction of the governing authority. Accordingly, merchants in the governing authority's jurisdiction readily accept payment for their goods and services with fiat currency objects because they know that they can in turn pay for goods and services in that jurisdiction with such fiat currency objects. However, the modern fiat currency objects of today are not the only type of currency objects.

Historically, the first type of currency objects developed were commodity items. A commodity item currency object consists of a physical commodity item that has an intrinsic value in itself. A common type of commodity item used historically as a currency object was precious metals, typically gold or silver. A governing authority would often make metal currency coins by placing a mark on the metal that served as a guarantee of the weight and purity of the metal. With a commodity item currency object, the commodity item object will retain its intrinsic value as a commodity item even if it is not used as a medium of exchange to pay for goods or services. Thus, for example, a commodity currency object that is a gold coin will still retain the value of the gold even if it is melted down and no longer a coin.

Evolving from the use of commodity object currencies were representative currency objects. Merchants or banks would issue written receipts to their depositors which were exchangeable for physical commodity items deposited with them (e.g. gold or silver coins). Such paper receipts became accepted as a means of payment by merchants who could exchange the receipt they had received in payment for the commodity items deposited with the issuing merchant or bank. Such privately issued written receipts used as a medium of exchange came to be a currency object known as a representative currency object. Representative currency objects helped commercial parties to a transaction avoid the inconvenience and expense of having to store, secure, transport and exchange typically heavier and bulkier physical commodity currency objects when conducting their transactions.

The written receipts issued by private banks exchangeable for commodity items deposited in the bank evolved into what came to be known as the banknote. A written banknote is a type of negotiable promissory note, made by a bank, that any bearer of the banknote can exchange on demand for the physical commodity items on deposit with the issuing bank. Banknotes were originally issued by private commercial banks, who were legally required by the governing authority of the jurisdiction that they operated in to exchange the banknotes for the legal tender of the governing authority (usually gold or silver coins minted by the governing authority) whenever the banknote was presented to the chief cashier of the issuing bank. The commercial banknotes traded at face value in the markets served by the issuing bank. The commercial banks issuing banknotes thus had to ensure that they could always pay customers in legal tender (es. the precious metal coins minted by the governing authority) when a person presented commercial banknotes for payment.

Eventually, national banknotes issued by the central banks of the governing authority for a jurisdiction came to mostly replace the private commercial banknotes. In contrast to a private commercial bank, a governing authority central bank possesses a monopoly on increasing the monetary base in the governing authority's jurisdiction, and also mints the currency objects which serve as legal tender in the governing authority's jurisdiction.

Historically, many governing authority central banks also followed the practice of basing their central bank banknotes with a commodity item, most often gold or silver. Thus, a money system that was a “gold standard” was one in which the governing authority issued currency objects (e.g. paper bills) that could be exchanged on demand into a fixed amount of gold from the governing authority. Today for a variety of economic reasons most governing authorities (i.e. governments) have abandoned commodity-based standards like the gold standard for their currencies: Most government issued currency objects have no basing in commodities and are simply fiat currencies.

While legal tender fiat currency embodiments issued by the central banks of governments have come to dominate the modern economy they are not the only currencies. Commercially issued currency objects can still exist where not prohibited by the law of a governing authority. One example in particular is the development and use of digital currency objects in recent decades.

A digital currency is a form of currency that is embodied only in an intangible digital or electronic form, and not in a tangible physical form. It is also called digital money, electronic money, electronic currency, or cyber cash.

Digital currency objects are intangible and can only be owned and transacted in by using computers or electronic wallets which are connected to the Internet or the designated networks. In contrast, the physical embodiment currency objects, like bank notes and minted coins, are tangible and transactions are possible only by holders who have physical possession of such currency objects.

Like any standard fiat currency, digital currency objects can be used to purchase goods as well as to pay for services from those willing to accept such digital currency objects as payment. Digital currency objects allow for instantaneous transactions that can be seamlessly executed for making payments across borders when connected to supported devices and networks. For instance, it is possible for an American to make payments in a digital currency embodiment to a distant counterparty residing in Switzerland, provided that they both are connected to the same network required for transacting in the digital currency object.

Digital currency objects offer numerous advantages. As payments in digital currency objects are made directly between the transacting parties without the need of any intermediaries, the transactions are usually instantaneous and zero- to low-cost. This fares better compared to traditional payment methods that involve banks or clearing houses. Digital currency object based electronic transactions also bring in the necessary record keeping and transparency in dealings.

A cryptocurrency object is a type of digital currency object which uses cryptography to secure and verify transactions and to manage and control the creation of new currency units. Bitcoin and Ethereum are two of the most popular cryptocurrency objects. However, while cryptocurrency objects like Bitcoin and Ethereum are growing in popularity they are still not widely accepted by merchants for goods or services.

A primary reason for this is that such cryptocurrency objects are not legal tender. Accordingly, there is no obligation for a seller of goods or services, or a governing authority, to accept payment in the form of cryptocurrency objects. Thus, a merchant who chooses to accept cryptocurrency objects as a form of payment takes a risk because there is no assurance that the merchant will be able to use the cryptocurrency objects received to make any payments the merchant has to make.

To minimize the risk to a merchant of accepting payment in a digital currency that is not a legal tender the merchant must be able to readily exchange such digital currency for the legal tender of the merchant's jurisdiction at a reliable exchange rate. There do exist cryptocurrency exchanges (e.g. Coinbase) where cryptocurrency objects (e.g. Bitcoins) can be exchanged for legal tender fiat currency objects (e.g. U.S. dollars). However, the exchange rates of cryptocurrency objects on such exchanges has not been reliable, with exchange rates showing extreme volatility of up to 20% on a daily basis. Thus, exchanges for cryptocurrency objects that are not based on real assets do not sufficiently reduce risk for accepting payment in cryptocurrency objects, because unless a payee can instantly exchange the cryptocurrency for a legal tender fiat currency the payee will be assuming a highly speculative position.

To address the volatile and unreliable exchange rate problem of virtual currencies that are not based on real assets a type of representative cryptocurrency known as “stablecoin” has been developed. As proposed a stablecoin cryptocurrency is a digital form of a representative currency that has its value pegged to legal tender fiat currencies, or to exchange traded commodities (such as gold, silver, other precious and industrial metals, etc). The value of stablecoins based on exchange-traded commodities relies on the value of the commodity. Holders of exchange-traded commodities based stablecoins can exchange their stablecoins at the conversion rate to take possession of commodity items.

An example of an existing commodity-based cryptocurrency stablecoin is Royal Mint Gold (RMG). RMG is a cryptocurrency issued by the United Kingdom's (UK) Royal Mint, which is the government owned company responsible for producing all the physical money the UK has for circulation. One RMG cryptocurrency unit represents ownership of 1 gram of real gold that is securely stored at the Royal Mint. Blockchain technology is used by the Royal Mint to issue a cryptocurrency object with each RMG unit being exchangeable for one gram of physical gold stored by the Royal Mint.

RMG cryptocurrency can easily be sent to anyone with a digital BitGo RMG Wallet, wherever and whenever a holder of RMG cryptocurrency chooses, allowing for cost effective and near instantaneous transactions that can be made at all times. Every RMG transaction made on the blockchain ledger is completely visible to everyone on the blockchain network, making it safe from accidental or deliberate destruction, ensuring that ownership of RMG cryptocurrency is secure.

Accordingly, RMG cryptocurrency can be accepted by a merchant for the payment of goods and services with the confidence of knowing that it is authentic (i.e. not counterfeit) through the use of blockchain technology, and that RMG cryptocurrency units can at any time be exchanged for physical gold from the UK Royal Mint. This assurance of being able to obtain ownership and possession of a physical commodity item like gold that can readily be converted into the legal tender of most jurisdictions at a known and relatively stable price greatly reduces the risk to a merchant of accepting a cryptocurrency like RMG as a payment from a payor.

A disadvantage however of the proposed and existing commodity-based digital currencies like RMG cryptocurrency is that the exchangeable value of the cryptocurrency is determined based on just a single physical attribute of the base commodity, which in the case of RMG is the weight of the gold. Thus, for example, the exchangeable value of one RMG cryptocurrency unit will be any one-gram gold piece controlled by the Royal Mint. The assumption therefore is that all such gold pieces which are of equal weight are the same and thus fully interchangeable with one another (i.e. completely fungible). However, this is not necessarily true.

The physical attribute of weight alone does not determine the value in legal tender fiat currency for a gold piece. Rather, the actual market value in a legal tender fiat currency for a gold piece depends upon both the weight and the purity of the gold piece. Thus, for example, a twenty-four Karat (99.9% pure) gold piece weighing one-gram will have a different value in legal tender fiat currency (e.g. U.S. dollars) than that of a nine Karat (37.5% pure) gold piece also weighing one-gram. This potentially significant difference in the value of a commodity item instance exchangeable for an RMG cryptocurrency unit based on the secondary discount physical attribute of purity is not considered when determining the value of an RMG cryptocurrency object. Only the primary physical attribute of weight is considered.

Accordingly, to provide recipients of a commodity asset-based currency like the RMG with assurance of what the legal tender fiat currency value of the base commodity asset will be it must be warranted by the issuing mint that there will be no variation in any secondary discount physical attributes of the base commodity assets. Such a warranty limits the choices the issuing mint has for base commodity assets to those where uniformity of any discount physical attributes can be readily and cost effectively achieved and assured.

But, limiting the available commodity base asset choices to just those where there is a uniformity of secondary discount physical attributes restricts the choice of available commodity items that can be used by the mint as a base for a currency object. The invention of applicant has an object overcoming this significant limitation for conventional commodity asset-based currencies. This object is achieved by providing for a new physical commodity-based currency that when issued has a value that reliably and accurately considers variations of secondary discount physical attribute values of a deposited commodity item, and thus expands the choice of commodity items available to act as an asset-base.

The present invention provides for a representative currency object that is based on an instance of a physical commodity item asset controlled by the issuing mint. The representative currency unit value of the issued representative currency object is determined by the solution to an innovative Commodity Value Scale (CVS) function for the commodity item type being used as a base asset. The inputs of the CVS function for an instance of a commodity item comprise a primary intrinsic physical attribute value, one or more discount intrinsic physical attribute values, and one or more conditional physical attribute values for such instance. The CVS function is derived from historical fiat currency legal tender prices for the physical commodity item type that includes data on price variations for a primary physical attribute and a discount intrinsic physical attribute

In a preferred embodiment of the applicant's invention the commodity-based currency is a cryptocurrency based on real diamonds securely stored by the issuing mint. However, the present invention is not limited to cryptocurrency objects or the use of diamonds as the base asset. The invention of applicant can be embodied in tangible currency objects or use any physical commodity item type for which there is sufficient historical price data from which to derive the CVS function. A description of the preferred embodiment for applicant's claimed invention is set forth below.

### BRIEF DESCRIPTION OF THE DRAWINGS

FIG. 1 is a schematic representation showing the creation of diamond based currency with an embodiment of the system of the present invention.

FIG. 2 is a schematic representation showing the redemption of diamond based currency for real diamonds with an embodiment the system of the present invention.

FIG. 3 is a schematic representation showing the process of acquiring a diamond that is eligible to exchange for currency generated using an embodiment of the system of the present invention.

FIG. 4 is a schematic representation showing the process of acquiring a utility currency that is necessary to pay for fees associated with an exchange of diamonds for currency when using an embodiment of the system of the present invention.

FIG. 5 is a flowchart representation showing the steps with the system of the present invention for determining a total denomination value of a commodity instance that will be a base for issued currency objects.

FIG. 6 is a flowchart representation showing the steps with the system of the present invention for removing minted currency objects from the currency system.

FIG. 7 is a schematic representation showing the CVS function database and associated data objects that is used in the system of the present invention.

FIG. 8 is a schematic representation showing the CVS function database and associated data objects that is used in an embodiment of the system of the present invention that uses diamonds.

FIG. 9 is a schematic representation showing an embodiment of the system of the present invention that mints cryptocurrency objects based on diamonds.

### BEST MODE FOR CARRYING OUT THE INVENTION

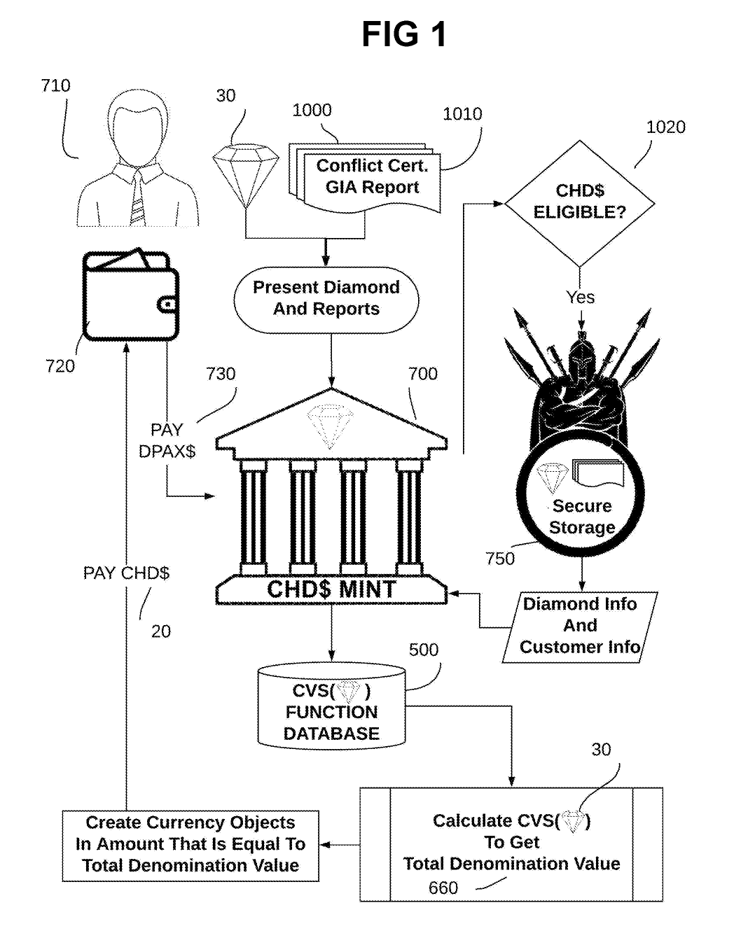

Referring to FIG. 1 there is shown a schematic representation of the system of the present invention 10 steps for creating (i.e. minting) one or more CHD$ currency objects 20 based on a secured instance 30 of a commodity item type (CIT), where the issued currency objects 20 have a total denomination value in currency units that accurately reflects the relative market value for secured instance 30. As used herein the term instance means a particular physical object of the CIT. For example, if the CIT is diamonds, then an instance 30 of the CIT diamonds would be a particular diamond.

### Valuation of Commodity Item Based Currency Objects

Previous methods of issuing CIT instance 30 based currency objects 20 did not permit the use of CIT base asset instances 30 which varied by more than one primary intrinsic physical attribute (hereinafter the “PIPA”). The most common PIPA historically used has been the weight of a CIT base asset instance 30, such as for example the weight in ounces or grams of a metal gold instance 30.

However, in many cases the relative market value for an instance 30 of a particular CIT will be affected by more than just its PIPA value. There is often at least one discount intrinsic physical attribute (hereinafter “DIPA”) value that also affects the relative price for an instance 30 of a CIT. An example such a DIPA would be the purity of an instance 30 of gold metal, with instances of gold 30 of the same weight that have different purities (i.e. the amount of gold metal in the instance 30 compared to other less precious metals) having different prices.

Similarly, in addition to intrinsic physical attribute values which are physical attributes inherent in every instance of a CIT, the price a CIT instance 30 may also be affected by at least one conditional physical attribute (hereinafter “CPA”) value. A CPA for an instance 30 of a CIT is not a physical attribute inherently present in every instance 30 of a CIT, but is an observable physical condition of an instance 30 of a CIT. An example of a CPA could be the physical processing of an instance 30 of a CIT, such as the cut of a diamond.

CIT instance 30 based currency objects with a denomination value that is assessed for CIT instances 30 that vary only in PIPA values (e.g. their weights), requires that any DIPA or CPA values of the base asset instances 30 be uniformly constant: This unduly restricts the CIT instances 30 that are available to use as currency base assets. There are many commodity item types that are readily exchangeable for fiat legal tender currencies, which offer a good store of value, and that could be used to base a currency issuance on if their DIPA and CPA values could be reliably accounted for when issuing currency that is based on by instances 30 of such commodity item types.

A preferred example of such a CIT would be polished diamonds which offer a number of advantages over a CIT like gold in terms of storage and transportation. However, unlike gold it is not practicable to limit the instances 30 of diamonds that can be used as currency base assets to only those that have the same combination of DIPA and CPA values. To use a CIT like diamonds there must be a way to accurately determine the relative value one instance 30 of diamond has relative to the value of another instance 30 of diamond where the instances 30 have the same PIPA value (e.g. weight) but different DIPA and/or CPA values (e.g. color, clarity and cut). This can be achieved with the system of the present invention which utilizes a Commodity Value Scale (hereinafter “CVS”) Function Database 500 that is derived from historical market price data for a CIT, such as diamonds.

### The CVS Function Database for A CIT

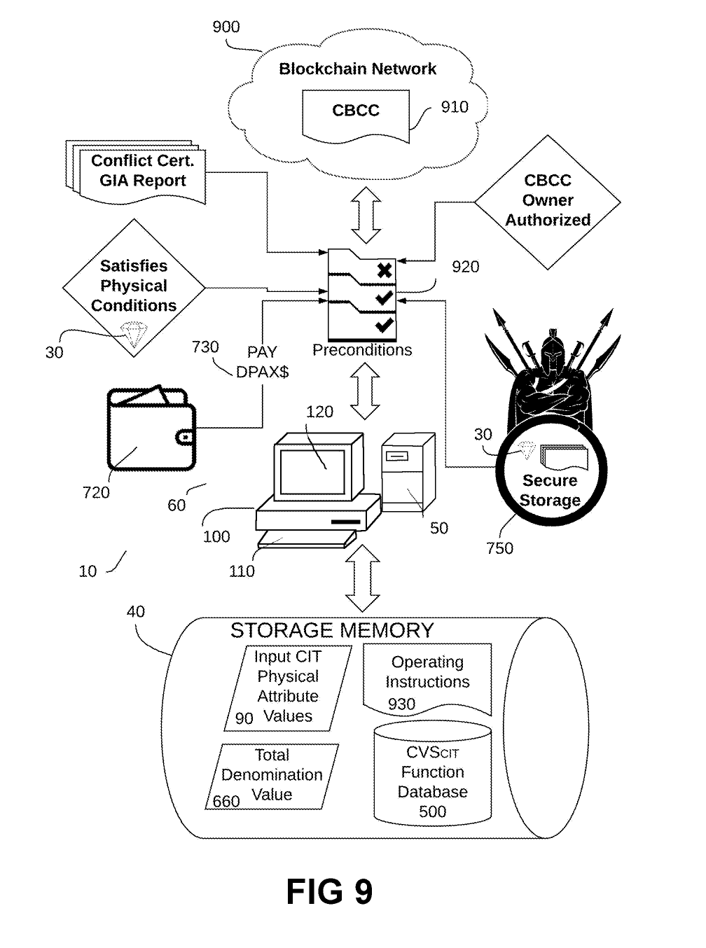

Central to the system of the present invention is the use of an innovative CVS Function Database 500. Referring to FIG. 9 it is contemplated in an preferred embodiment of the system of the present invention that CVS Function Database 500 for a particular CIT (e.g. diamonds) shall be located in a storage memory 40 that is a part of, or accessible to, a processor 50 of a computing system 60. By way of example and not limitation storage memory 40 may be a physical component of general-purpose computer station 100. In such cases storage memory 40 may be any electronic or optical computer readable storage medium, such as by way of example, ROM, RAM, a hard disk drive, flash memory, optical disk etc. Some or all of storage memory 40 may also be located remotely from computer station 100 and be accessible to processor 50 located in computer station 100 over a communications network such as Wi-Fi, Bluetooth, Ethernet, the Internet, etc. . . . .

Parts or all of the CVS Function Database 500 may also exist in visually perceptible tangible form, such as for example a printed catalog of CVS functions, with each CVS function in the catalog being visually displayed along with associated information such as a human readable data representation of the physical attributes of a CIT instance 30 (e.g particular combinations of PIPA, DIPA, and CPA values for an instance 30), as well as a computer readable data representation such as a bar code that may be scanned by a bar code reader of the system. Thus, a person using the system 10 may enter a data representation into the system using an input mechanism 110 such as a keyboard and/or mouse, or may scan a data representation of the physical attributes of a CIT instance 30 into the system from a barcode.

In the contemplated preferred embodiment computing system 60 has an input mechanism 110 and an output mechanism 120. A significant function of input mechanism 110 is to receive the input of instance 30 physical attribute data 90 that is to be placed in storage memory 40 for access by processor 50. Data 90 for purposes of the system of the present invention is contemplated to include a primary input value, one or more discount input values, and possibly one or more conditional input values for an instance 30 of a CIT to be evaluated by the system for purposes of determining the total denomination value of one or more currency objects 20 which can be issued on account of such instance 30.

Output mechanism 120 of the system of the present invention is contemplated to include devices than can communicate, display, and record the total denomination value of one or more currency objects 20 which can be issued on account of an instance 30 as determined by the system of the present invention. Accordingly, by way of example and not limitation, such output mechanisms would include internal and external data busses of computing system 60, sensory displays such as visual monitors or audio speakers, and network communication devices that facilitate the communication of data between memory locations and processors of different computing systems, including but not limited to a plurality of computing devices which may comprise a network, such as for example a blockchain network.

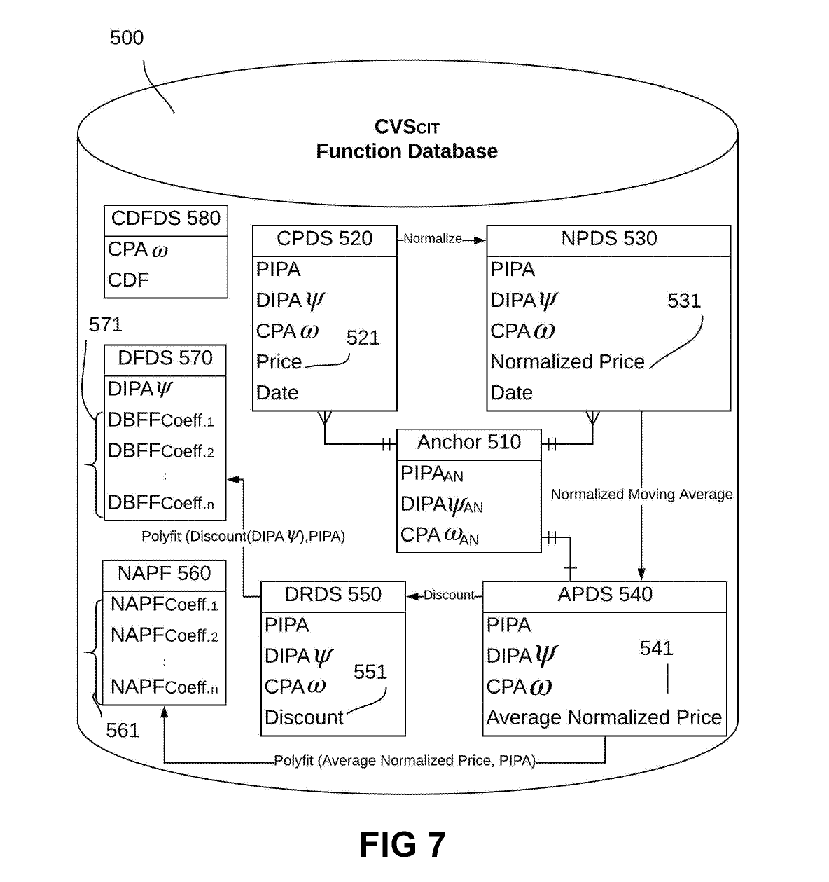

Referring to FIG. 7 the CVS Function Database 500 of the system of the present invention comprises a plurality of instances of data objects (i.e. data structures) each of which is comprised of individual record structures having one or more fields for holding values. In the exemplary embodiment of FIG. 7 the CVS Function Database 500 for a CIT comprises instances of an anchor data object 510, CIT Price Data Set (CPRS) data object 520, a Normalized Price Data Set (NPDS) data object 530, an Average Price Data Set (APDS) data object 540, a Discount Record Data Set (DRDS) data object 550, a Normalized Average Price Function (MAPF) data object 560, a Discount Factor Data Set (DFDS) data object 570, and a Conditional Discount Factor Data Set (CDFDS) data object 530. CVS Function Database may 500 may exist as an object orientated database management system (OODBMS), but may also be implemented in other forms such as, by way of example, a relational database.

The data objects shown in FIG. 7 are just examples of data objects and/or their record structure fields which may be incorporated into CVS Function Database 500 for a preferred contemplated embodiment of the system of the present invention. Other data objects and/or record structure fields may also be used.

### The Anchor Object 510

Referring to FIG. 7 there is shown in the CVS Function Database 500 an anchor data object 510 has a record structure with fields to store defined physical attribute values for an anchor (i.e. a reference) instance of the CIT. In the system of the present invention it is contemplated that anchor data object 510 will have just one record whose field values define an anchor instance of the CIT. The values for the anchor data object 510 are used to identify specific records in some of the other data objects of CVS Function Database 500. These “anchor instance” records in such data objects are used in normalizing other records in the data objects. Accordingly, when reference is made herein to an anchor instance record for a data object of the CVS Function Database 500 it means the record in the data object that has same the physical attribute values as the anchor instance defined by anchor object 510.

The defined physical attribute values used for an anchor instance are in the discretion of the user (e.g. the currency issuing mint) of the system of the present invention. The anchor instance is defined only once when CVS Function Database 500 is first populated with historical CIT price data. Updates to CIT price data in the CVS Function Database 500 to keep the system current and accurate does not result in a change to the definition of the anchor instance.

### The CIT Price Data Set (CPDS) Object 520

Referring to FIG. 7 there is shown a CIT price data set (CPDS) object 520 that contains a plurality of historical market price records for the CIT. The historical price records of CPDS 520 preferably are denominated in a currency that is a fiat legal tender currency, and which covers a plurality of time periods (TP). The intervals of the price records in CPDS 520 between time periods should also be uniform, and may for example be measured in years, months, weeks, days, hours, minutes, or seconds as appropriate for the particular CIT.

As is shown each record of CPDS 520 is contemplated to have a record structure that has a date value field, a PIPA value field, one or more fields for DIPA values, and a field for a price value. In some cases, inclusion of one or more fields CPA values may also be desirable. The particular combination of DIPA values an instance of a CIT has is designated herein by φ. Accordingly, in FIG. 7 the combination of the DIPA value fields a record structure in a data object has is shown as DIPAφ. Similarly, the particular combination of CPA values an instance of a CIT has is designated herein by ω. Accordingly, in FIG. 7 the combination of the CPA value fields a record structure in a data object has is shown as CPAω.

The records in CPDS 520 that have the same date field value define a time period subset of price records CPDS_{TP}. Every price record in a CPDS_{TP} subset should have a unique combination of PIPA, DIPAφ, and to the extent included CPAω values. All CPDS_{TP} subsets in CPDS 520 should have the same number of records with the same corresponding unique combinations of PIPA, DIPAφ, and CPAω values. If the records in CPDS 520 covers n time periods, then the total records in CPDS 520 is equal to the sum of the records in each CPDS_{TP} subset: CPDS=Σ₁ⁿ{CPDS_{TP}}ₙ. As mentioned above the time interval between all of the adjacent CPDS_{TP} subsets should be uniform (i.e. the time interval between {CPDS_{TP}}₁ and {CPDS_{TP}}₂ should be the same as the time interval between {CPDS_{TP}}ₙ₋₁ and {CPDS_{TP}}ₙ).

It should be noted that while the preferred exemplary embodiment of the system of the present invention using diamonds has instances which have two DIPA values (color and clarity) and one CPA value (cut), the system of the present invention may also be used with a CIT that has instance which do not have any known DIPA values and/or CPA values. In such a case the values used for DIPA fields and a CPA fields in CPDS 520 may be set to a single constant number of the anchor object 510 that will not vary across the records of CPDS 520. In this way the DIPAφ and CPAω discount rate values obtained from the CVS Function Database 500 for when evaluating an instance of such a CIT should always equal one, which results in there never being a discount rate applied to the solution of the normalized average price function based on the PIPA of an instance of such CIT.

### The Normalized Price Data Set (NPDS) Object

Referring to FIG. 7 a data object NPDS 530 is shown in CVS Function Database 500. The records in NPDS 530 are derived from the records of CPDS 520 in accordance with Formula 1 below. Specifically, each individual record CPDS_{X}_{_{TP}} from a subset CPDS_{TP} is copied into NPDS 530 as a corresponding record NPDS_{X}_{_{TP}}. Accordingly, the record structure of CPDS 520 and NPDS 530 is the same in terms of fields, with the one exception of the price field. Specifically, in NPDS 530 the price field 521 of CPDS 520 is transformed into a normalized price field 531. The value of the normalized price field (NPDS_{X}_{_{TP}}: Normalized Price) 531 for each record NPDS_{X}_{_{TP}} in NPDS 530 is calculated to be equal to the price field value (CPDS_{X}_{_{TP}}: Price) 521 of the corresponding record CPDS_{X}_{_{TP}} in CPDS_{TP} divided by the price field value (CPDS_{AN}_{_{TP}}: Price) 521 of the anchor instance record CPDS_{AN}_{_{TP}} in CPDS_{TP}. As shown in Formula 1 the anchor instance record CPDS_{AN}_{_{TP}} in a CPDS_{TP} is the record in the CPDS_{TP} that has the same PIPA, DIPAφ and CPAω field values as the anchor object 510:

NPDS_{X}_{_{TP}}:Normalized Price=(CPDS_{X}_{_{TP}}:Price)/(CPDS_{AN}_{_{TP}}:Price)

CPDS_{AN}_{_{TP}}={CPDS_{TP}|PIPA_{X}_{_{TP}}=PIPA_{AN}∧DIPAφ_{X}_{_{TP}}=DIPAφ_{AN}∧CPAGω_{X}_{_{TP}}=CPAω_{AN}} Formula 1

### The Average Price Data Set (APDS) Object 540

Referring to FIG. 7 a data object APDS 540 is shown in CVS Function Database 500. In APDS 540 the record structure has a field for a PIPA value, one or more fields for DIPAφ values, one or more fields for CPAω values, and a field 541 for average normalized price. The records of APDS 540 are derived from the records of NPDS 530. More specifically, each record in APDS 540 is derived from a set of records PA_{ϕ} that is a subset of the NPDS 530 records.

A PA_{ϕ} record subset in NPDS 530 consist of all records in NPDS 530 which have the same ϕ combination of PIPA, DIPAφ and CPAω values. In other words, the records in NPDS 530 across all time periods in NPDS 530 that have the same values for PIPA, DIPAφ and CPAω are the records in a set PA_{ϕ}.

For each ϕ combination of PIPA, DIPAφ and CPAω there is one APDS_{ϕ} record in APDS 540 that has the same ϕ combination of PIPA, DIPAφ and CPAω field values. As shown in Formula 2 below the value of the average normalized price field (APDS_{ϕ}: Price) 541 for each APDS_{ϕ} record in APDS 540 is equal to the average of the normalized price field values 531 for the PA_{ϕ} records as determined by the solution of an Average Function (AF):

APDS_{ϕ}:Price=AF({PA_{ϕ}:Price}) Formula 2

In a preferred embodiment of the system of the present invention the average function AF that is used calculates the exponential weighted moving average for the price field values 531 in PAϕ for the number of time periods in PAϕ. Other types of AF however may also be used with the invention.

### The Discount Rate Data Set (DRDS) Object 550

Referring to FIG. 7 a data object DRDS 550 is shown in CVS Function Database 500. Each record of DRDS 550 is derived from the records of APDS 540. Specifically, each individual record APDS_{X} is copied into DRDS 550 as a corresponding record DRDS_{X}. Accordingly, the record structure of DRDS 550 and APDS 540 is the same in terms of fields, with the exception of the discount field 551 and average normalized price field 541. Specifically, in DRDS 550 the price field value 541 of APDS 540 is transformed into a discount rate vale in discount field 551.

The value of the discount field (DRDS_{X}: Discount) 551 for each record DRDS_{X} in DRDS 550 is calculated to be equal to ratio of the APDS_{X}:Average Normalized Price value 541 to the APDS_{AN}:Average Normalized Price value, where APDS_{AN} is the record in APDS 540 that has the same physical attribute values as the anchor instance object 510. As shown in Formula 3 the anchor instance record APDS_{AN} in APDS 540 is the record APDS_{X} in APDS 540 such that PIPA_{X}=PIPA_{AN} and DIPA_{φX}=DIPA_{φAN} and CPA_{ωX}=CPA_{ωAN}:

DRDS_{ϕ}:Discount=(APDSϕ:Price)/(APDS_{AN}:Price)

APDS_{AN}={APDS|PIPA_{X}=PIPA_{AN}∧DIPAφ_{X}=DIPAφ_{AN}∧CPAω_{X}=CPAω_{AN}} Formula 3

### The Normalized Average Price Function (NAPF) Object 560

Referring to FIG. 7 a data object NAPF 560 is shown in CVS Function Database 500. The record structure in NAPF 560 has fields for holding the coefficient values 561 for the normalized average price function: NAPF_{CIT}(PIPA). NAPF_{CIT}(PIPA) models the relationship between the average normalized price field values in APDS 541 and PIPA values for the CIT. In a preferred embodiment of the system of the present invention obtaining the values for NAPF_{CIT}(PIPA) starts with a polynomial regression analysis performed on the normalized average price field values 541 and PIPA values in APDS 540. The result of this polynomial regression analysis is a best fit polynomial function of APF(PIPA) as shown in Formula 4.

APF(PIPA)=Polyfit APDS(Price,PIPA) Formula 4
Polyfit APDS(Price, PIPA)=A polynomial function that is derived from a polynomial regression analysis of the relationship between the average normalized price field values and PIPA field values in APDS 540.

The acquisition of the coefficient values for NAPF_{CIT}(PIPA) is completed as shown in Formula 5 below by normalizing the APF(PIPA) such that its solution for PIPA_{AN} of the defined anchor object 510 will always be a specific number (CurrencyUnits_{AN}):

NAPF_{CIT}(PIPA)=APF(PIPA)*[Currency_{AN}/APF(PIPA_{AN})] Formula 5

The specific value of Currency_{AN} is determined by the user of the system of the present invention. It is recommended that Currency_{AN} be set to a value such that no instance of the CIT anticipated to be used with the system as a base asset for currency could be valued at less than a single currency unit.

The normalized best fit polynomial function NAPF(PIPA) has its function coefficients and constant values 561 stored in NAPF 560. In the exemplary preferred embodiment where diamonds are the CIT NAPF_{CIT}(PIPA) is a quadratic polynomial function.

### The Discount Function Data Set (DFDS) Object 570

Referring to FIG. 7 a data object DFDS 570 is shown in CVS Function Database 500. Each record of DFDS 570 is derived from the records of DRDS 550 and contains the coefficient and constant values 571 for the discount bet fit function (DBFFφ(PIPA)) of the discount rate values 551 for an instance of the CIT that has a particular combination y of DIPA as a function of PIPA values. Accordingly, each record in DFDS 570 has one or more fields for holding DIPA values of combination φ, and one or more fields for the coefficient and constant values of the DBFF_{φ} (PIPA).

The DBFFφ(PIPA) coefficient and constant values 561 of each record in DFDS 570 are derived from a subset of records DR_{φ} in DRDS 550 records. Specifically, the DR_{φ}, record subset of DRDS 550 consists of all records in DRDS 550 which have the φ combination of DIPA values. For each DR_{φ} set of records that exists in DRDS there is one corresponding record in DFDS 570 that has the value of its DIPA fields equal to the combination φ.

The values for DBFFφ of each DFR_{φ} are the coefficients and constants 571 of the function that best models the relationship between the discount field values and PIPA field values for the DR_{φ} record subset in DRDS: In a preferred method of obtaining these coefficient and constant values 571 of DBFFφ(PIPA) for a particular φ combination of DIPA values a polynomial regression analysis is done of the discount field values 551 and PIPA field values for the DR_{φ} set of records.

DBFFφ(PIPA)=Polyfit DRφ(Discount,PIPA) Formula 6
Polyfit DRφ(Discount, PIPA)=A polynomial function that is derived from a polynomial regression analysis of the relationship between the discount field values and PIPA field values of the DR_{φ} record subset in DRDS.

A DBFFφ(PIPA) function will take as its input the PIPA value of an instance of the CIT that has the φ combination of DIPA values. The solution of the DBFFφ(PIPA) for such instance of the CIT having φ combination of DIPA values and a PIPA value will be a discount rate factor (DRFφ) with a value of between zero and one: 0≤DRFφ≤1.

### The Conditional Discount Factor Data Set (CDFDS) Object 580

Referring to FIG. 7 a data object CDFDS 580 is shown in CVS Function Database 500. Each record of CDFDS 580 has one or more fields with a unique combination ω of CPA values (CPAω), and also field for a conditional discount factor (CDF) value. CDF values are generally based on anecdotal or empirical information regarding the effect on price a particular ω of CPA values has. In the contemplated preferred embodiment 0≤CDFω≤1 for all CPAω.

### Using the CVS Function Database to Compute Total Denomination Value

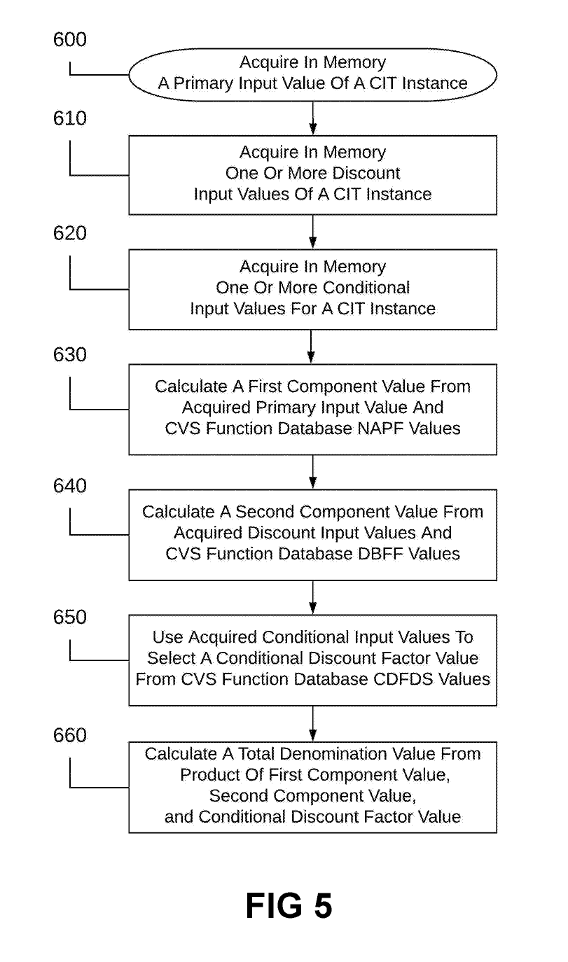

Referring to FIG. 5 the steps performed with the system of the present invention for determining the total denomination value in currency units of an instance of a CIT are shown. At least one operating instruction 930 in storage memory 40 is executed by a system processor 50 to receive through an input mechanism 110 a primary input value 600 for the PIPA value, one or more discount input values y 610, and in some cases one or more conditional input values w 620 of the instance, all of which are stored as input data 90 in storage memory 40.

At least one operating instruction 930 in said storage memory 40 is executed by a system processor 50 to determine a first component value NAPF_{CIT}(PIPA_{IN}) 630, where PIPA_{IN} is the primary input value 600, and NAPF_{CIT}(PIPA_{IN}) 630 is the solution for PIPA_{IN} of the normalized average price function with the coefficient and constant values 561 stored in NAPF 560 of CVS Function Database 500 for the CIT.

At least one operating instruction 930 in said storage memory 40 is executed by a system processor 50 to select the record from DFDS object 570 that has the same φ DIPA field values as the one or more discount input values φ 610. At least one operating instruction 930 in said storage memory 40 calculates a second component value 640 that is the solution for DBFFφ(PIPA_{IN}) using the coefficient and constant values 571 for the DBFF of the selected record.

In cases where conditional input values ω 620 are input, at least one operating instruction 930 in storage memory 40 is executed by a system processor 50 to select from said CDFDS object 580 a conditional discount factor 650 from the record having the same CPA field values as the one or more discount input values ω 620.

At least one operating instruction 930 in said storage memory 40 is executed by a processor 50 of said system to set a total denomination value CVS_{CIT}(IN) 660 in currency units for the evaluated instance to be equal to a calculated product of the first component value 630 (NAPF_{CIT}(PIPA_{IN})) and the second component value 640 (DBFFφ(PIPA_{IN})).

If there is also a conditional discount factor, then at least one operating instruction 930 in said storage memory 40 is executed by a processor 50 so that the total denomination value CVS_{CIT}(IN) 660 is set to equal the product of the first component value 630 (NAPF_{CIT}(PIPA_{IN})) and the second component value 640 (DBFFφ(PIPA_{IN})) and the conditional discount factor:

CVS_{CIT}(IN)=NAPF_{CIT}(PIPA_{IN})*[DBFF_{CIT}(φ)o(PIPA_{IN})]*CDF_{CIT}(ω) Formula 7
CIT=commodity item type
IN=an evaluated instance of the CIT
NAPF_{CIT}=normalized average price function for the CIT
PIPA_{IN}=PIPA value for IN
φ=DIPA values for IN
DBFF_{CIT}(φ)=DBFF of the CIT for DIPA values=φ.
ω=CPA values for IN
CDF_{CIT}(ω)=CDF value for the CIT with CPA values=ω.

Accordingly, the solution of NAPF_{CIT}(PIPA_{IN}) will produce a first component value number 630. The solution of DBFF_{CIT}(φ) o (PIPA_{IN}) is the solution of the DBFFφ function retrieved from the CVS Function Database 500 for the particular DIPAφ of the instance input into the system and will use PIPA_{IN} as its input: (DBFFφ(PIPA_{IN})). The solution of this will be a second component value number 640 that is between zero and one. Similarly, the solution to CDF_{CIT}(ω) is the conditional discount factor value number 650 retrieved from the CVS Function Database 500 for an instance having CPA values equal to ω: This will also be a value between zero and one. The first component value 630, the second component value 640 and the conditional discount factor 650 are multiplied together to give a resulting total denomination value in currency units 660 for the evaluated instance.

### Creating Currency Objects

Referring to FIG. 9 after a total denomination value in currency units 660 is determined for an instance using the CVS Function Database 500, one or more currency objects 20 may be created by the system equal in value to the total denomination value 660 calculated.

A currency object 20 is anything transferable which may be used as a medium of exchange to pay for goods, services or repayment of debts. A currency object 20 for the present invention may be a tangible physical object or an intangible object existing as stored information.

### Tangible Currency Objects

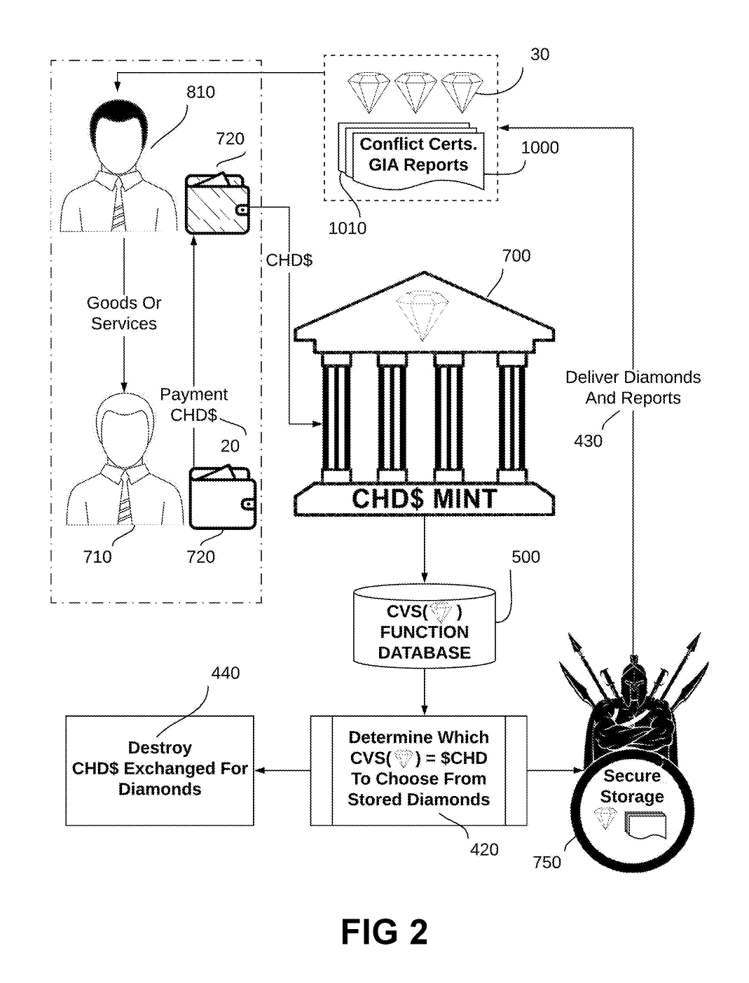

An example of a tangible physical currency object 20 of the present invention may be a conventional negotiable paper bill having printed on it a face value of the currency units it represents. Referring to FIG. 1 upon the deposit by a depositor 710 of a CIT instance 30 an issuing mint 700 using the system of the present invention could produce one or more such negotiable paper bill currency objects 20 whose combined face values in currency units would be equal to the total denomination value CVS_{CIT}(IN) 660 that is obtained using the CVS Function Database 500 records for the CIT instance 30. Referring to FIG. 2 at any time a different bearer 810 of such negotiable paper bill currency objects 20 issued by mint 700 can exchange them on demand for one or more CIT base asset instances 30 that are on deposit with the issuing mint 700 and that have a total denomination value 660 as determined using the CVS Function Database 500 records at such time that is equivalent to the face value of such negotiable paper bills currency objects 20.

As explained above, in a preferred implementation of the present invention a CIT base asset instance 30 that has the properties of the defined anchor object 510 of the CIT will have a total denomination value in currency units 660 that does not change with time. Thus, for example, an instance 30 of the CIT deposited at an original time that has the physical attributes of the defined anchor object 510 may have currency objects 20 with a face value of $X currency units (Curreny_{AN}) issued in accordance with the CVS Function Database records as they exist at that original time. If at a later date there are changes in the market that affect the relative values of CIT instances 30 having different physical attributes, then this would be reflected in the records of a well-maintained. CVS Function Database 500 that keeps CPDS 520 records current. However, $X currency objects 20 will still have a exchangeable value of an instance 30 of the CIT that has the anchor instance 510 physical attributes. The total denomination value in currency units though that would be calculated using the system for a non-anchor instance 30 of the CIT would be different than the value at the original time value reflecting the changes in the market.

### Cryptocurrency Objects

Referring to FIG. 9, while the system of the present invention may be used to create (i.e. issue or mint) tangible currency objects as described above, in a preferred use of the system the one or more currency objects 20 minted will be digital currency objects. More specifically, one or more digital cryptocurrency tokens 20 minted using a blockchain network 900 such as, by way of example and not limitation, the Ethereum blockchain network.

A cryptocurrency token is a special digital currency token that resides on its own blockchain and represents an asset or utility. For example, one can have a cryptocurrency token that represents a number of customer loyalty points on a blockchain that is used to manage such details for a retail chain. There can be another cryptocurrency token that gives entitlement to the token holder to view a number of hours of streaming content on a video-sharing blockchain. Another cryptocurrency token that may even represent other cryptocurrency, like one such cryptocurrency token being equal to a number of Bitcoins on a particular blockchain. Such cryptocurrency tokens are tradable and transferable among the various participants of the blockchain.

Such cryptocurrency tokens often serve as the transaction units on the blockchains that are created using the standard templates like that of Ethereum network that allows a user to create his/her own tokens. Such blockchains work on the concept of smart contracts or decentralized applications, where the programmable, self-executing code is used to process and manage the various transactions occurring on the blockchain. A smart contract 910 is a self-executing contract with the terms of the agreement between parties to the contract directly written into lines of computer code. Such terms may include a number of preconditions 920 that must be satisfied before execution of certain aspects of the smart contract 910. The computer code, and by correlation the agreements embodied in the computer code, exist across a distributed, decentralized blockchain network 900. Accordingly, smart contract 910 transactions (executions of the computer code on the blockchain) are traceable, transparent, and irreversible. Thus, a cryptocurrency token 20 operates on top of a blockchain 900 (e.g. Ethereum) that acts as a medium for creation and execution of the smart contract 910 that embodies the cryptocurrency token 20. Cryptocurrency tokens 20 may be created, distributed, sold and circulated through a standard initial coin offering (ICO) process that involves a crowdfunding exercise to fund project development.

In a preferred embodiment of the system of the present invention currency objects 20 are issued as cryptocurrency tokens defined by a smart contract 910 on the Ethereum blockchain 900. More specifically, source code written in the object-oriented high-level language Solidity is used to create a smart Commodity-Based Currency Contract (CBCC) 910 for compilation and deployment on the Ethereum Virtual Machine (EVM) 900. In the preferred implementation of the invention the CBCC 910 is owned and controlled by a mint 700. In a preferred embodiment the cryptocurrency objects 20 of the CBCC 910 are ERC20 (Ethereum Request for Comment 20) compliant.

In the cryptocurrency token implementation of the present invention, mint 700 receives and stores instances of the CIT and creates cryptocurrency tokens for the CBCC 900 in amounts equal to the solution of CVS_{CIT}(IN) 660 for the received instances at the time of their receipt. Similarly, the mint 700 exchanges issued cryptocurrency tokens 20 for instances 30 of the CIT it has and whose total denomination value at the time of the exchange as calculated using the system of the present invention equals the face value of the cryptocurrency objects 20.

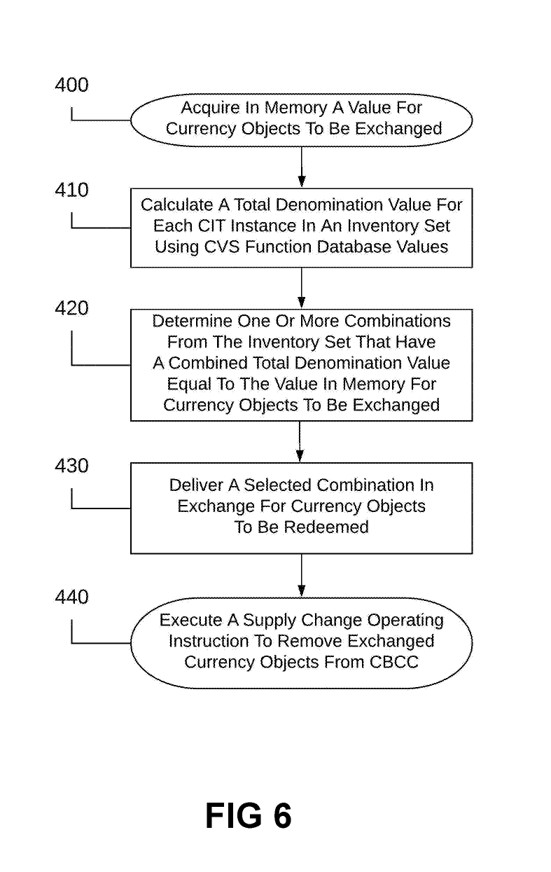

Referring to FIG. 6, in a preferred implementation of the system any cryptocurrency tokens 20 received by the mint in exchange for instances 30 of the CIT in the secure control 750 of the mint 700 will be destroyed (i.e. burned or deleted from CBCC 910) by the mint 70. In this way the total supply (TS) of cryptocurrency tokens in the CBCC 910 continues to be based on instances 30 of the CIT in the secure control of the mint 700: The TS will always be equal to the total number of cryptocurrency units 20 that have been created for instances 30 of the CIT received by the mint 700, minus the total numbers of currency units 20 that have been exchanged for instances 30 of the CIT and then destroyed by the mint 700:

CBCC_{TS}=Σₘᵢₙₜ₌₁^{X}CVS_{CIT}_{ₜ}(INₘᵢₙₜ)−Σ_{burn=1}^{Y}CVS_{CIT}_{ₜ}(IN_{burn}) Formula 8
CBCC_{TS}=Total supply of cryptocurrency tokens in the CBCC
X=Number of instances of CIT deposited for currency created
Y=Number of instances of CIT exchanged for currency units
CVS_{CIT}_{ₜ}=The CVS function for the CIT at the time t when the CIT instance was received or exchanged for cryptocurrency tokens.

Ownership and control of the CBCC 910 by the mint 700 is coded into the CBCC 910 on the blockchain 900, which gives the mint 700 exclusive access and control over the coded functions in the CBCC 910 that are necessary to change the assigned value of TS in the CBCC 910 for the total supply of cryptocurrency tokens 20 existing.

Referring to FIG. 2 The cryptocurrency token supply of the CBCC 910 may be transferred between users of the blockchain in transactions recorded on the blockchain using any wallet application 720 compatible with the particular blockchain 900 used for the CBCC 910. Thus, by way of example, a CBCC 910 implemented on the EVM 900 which has ERC20 compliant cryptocurrency tokens 20 may be used in transactions with Ethereum compatible wallet applications 720 such as Mist, Metmask, Exodus, MyEtherWallet and TrustWallet.

### An Exemplary Implementation Using Diamonds as the CIT

In an exemplary embodiment of the system of the present invention the CIT used as a base asset for issuance of one or more cryptocurrency objects is polished diamonds.

### Benefits of Diamonds as a CIT Base Asset:

In recent years there has been a great expansion of cryptocurrencies like Bitcoin and Ether. However, these typical cryptocurrencies are not based on real assets and fluctuate in fiat legal tender currency by up to 20% on a daily basis. For a currency object (cryptocurrency or tangible) to be an effective medium of exchange it must have reasonable stability with respect to fiat legal tender currencies which a payee knows can be used to pay for goods, services and debts in their jurisdiction. Having a commercially issued cryptocurrency object based on a CIT which is a real physical asset that can readily be converted into fiat legal tender currency object would reduce the volatility of the commercial cryptocurrency object to at least approximately the volatility of CIT base of the cryptocurrency.

Basing a cryptocurrency on a CIT asset such as gold is known. However, the present invention provides a method of issuing currency objects that are based on a CIT whose market value may depend upon a plurality of physical attributes. The invention thus expands the choice of available CIT instances that are available for use as base assets of a currency object. In a preferred exemplary embodiment of the invention a CIT which could not previously be effectively used as a base asset for currency objects due to its value depending upon a plurality of physical attributes is polished diamonds.

Diamonds are smaller and lighter than their equivalent value in a precious metal commodity such as gold making diamonds easier to store and transport, they are a good store of value, and they are readily exchangeable for fiat legal tender currencies. Accordingly, diamonds are an example of CIT which can be an excellent base asset for a currency object if their value for such purposes can be reliably and accurately determined. The present invention provides for this.

### Diamond Physical Attribute Value Factors

There are two broad categories of polished diamonds: Fancy diamonds and non-fancy diamonds. Fancy diamonds are “colored diamonds” meaning that they have colors outside the range of non-fancy diamonds which represent the vast majority of polished diamonds. In diamonds, rarity equals value. With non-fancy diamonds in the normal range, value is based on the absence of color, because colorless diamonds are the rarest. With fancy color diamonds—the ones outside the normal color range—the rarest and most valuable colors are saturated pinks, blues, and greens. In all cases, even very slight color differences can have a big impact on value. Because most polished diamonds are non-fancy diamonds, unless otherwise expressly stated herein any reference to the term diamond should be interpreted to mean a non-fancy polished diamond.

Polished diamonds are graded according to four physical criteria which were established in the 1940s by the Gemological Institute of America (GIA). With polished diamonds the four GIA physical criteria are known as the “4Cs” and stand for (1) Carat, (2) Color, (3) Clarity and (4) Cut.

Carat is a term used to describe the physical weight of a polished diamond. One carat is equal to 0.2 grams (i.e. 200 mg). Each carat can be subdivided into 100 ‘points.’ This allows very precise measurements in carats to the hundredth decimal place (e.g. 1.08 carats). All else being equal, diamond price increases with diamond carat weight because larger diamonds are rarer and more desirable. But two diamonds of equal carat weight can have very different market prices depending on three other physical attributes of the polished diamond: Color, Clarity and Cut.

The diamond physical attribute of color is evaluated based on the absence of color for non-fancy diamonds. A chemically pure and structurally perfect diamond has no hue, like a drop of pure water, and consequently, a higher value the GIA's color-grading system for diamonds is a D-to-Z alphabet scale (for twenty-three total categories) that represents a measure of the degree of colorlessness by comparing a polished diamond stone under controlled lighting and precise viewing conditions to masterstones of established color value.

The physical attribute of clarity for a diamond is a measure of the absence of inclusions and blemishes. Natural diamonds are the result of carbon exposed to tremendous heat and pressure deep in the earth. This process can result in a variety of internal characteristics called ‘inclusions’ and external characteristics called ‘blemishes.’ Evaluating the physical attribute of clarity involves determining the number, size, relief, nature, and position of these characteristics, as well as how these affect the overall appearance of the stone. While no diamond is perfectly pure, the closer it comes, the higher its value. The GIA Diamond Clarity Scale has six categories, some of which are divided, for a total of eleven specific grades.

The observable physical quality of a polished diamond to transmit light and sparkle is determined by its cut. The GIA grade for diamond cut is an evaluation of how well a diamond's facets interact with light and is the most complex and technically difficult to analyze. To determine the cut grade of the standard round brilliant diamond—the shape that dominates the majority of diamond jewelry—the proportions of those facets that influence the diamond's face-up appearance are calculated. Also considered is the design and craftsmanship of the diamond, including its weight relative to its diameter, its girdle thickness (which affects its durability), the symmetry of its facet arrangement, and the quality of polish on those facets. The GIA Diamond Cut Scale for standard round brilliant diamonds contains five grades of Excellent, Very Good, Good, Fair, or Poor. A diamond's cut is crucial to the stone's final beauty and value.

In an exemplary embodiment of the present invention that uses instances of diamonds as the CIT as base assets for issued currency objects the physical attributes of carat, color, clarity and cut would be identified as the physical attribute values affecting the market price of the CIT. An empirical assessment of the diamond market reveals that the weight of diamonds (carats) is a primary determining factor of value, and hence is chosen as the PIPA. The other intrinsic physical attributes that will cause the value for a diamond of a certain weight to be discounted from that for a anchor instance diamond of the same weight are the color and clarity values. Accordingly, the DIPA values for an instance of a diamond will be its values for color and clarity. The final attribute of an instance of diamond that will cause the value for a diamond of a certain weight, color and clarity to be discounted from that for an anchor instance diamond of the same weight, color, and clarity is the cut value. Because cut is an observable but not inherent physical attribute of a diamond it is considered a conditional physical attribute (CPA) of a diamond instance.

CIT=Diamond
PIPA=Carats (weight)
DIPA₁=Color
DIPA₂=Clarity
CPA₁=Cut

### The Exemplary Diamond Mint

### SwissDiamondCoin Mint

In the exemplary diamond CIT system of the invention it is contemplated that a mint entity would secure instances of diamonds to be used as base assets for exchangeable cryptocurrency tokens under an Ethereum based CBCC owned and controlled by the mint. The mint is contemplated to be an independent non-profit entity called the SwissDiamondCoin Foundation, and the cryptocurrency tokens created are called SwissDiamondCoins which have the symbol CHD$.

### An Asset Based Currency Platform (ABCP)

Referring to FIG. 9, the operations of the mint 700 are contemplated to be implemented on a computing system 60 that comprises an Asset Based Cryptocurrency Platform (hereinafter the “Platform” or “ABCP”). The ABCP is contemplated to provide the infrastructure backbone of the SwissDiamondCoin currency (CHD$) which is implemented using the system of the present invention. The ABCP is coordinated and overseen by the mint 700. The ABCP contemplated consists of:
Software:
   ABCP Protocol (Smart Contracts)
   ABCP mobile App for end users (CHD owners)
   Decentralized User ID management, facilitating Know Your Customer (KYC) and Anti-Money Laundering (AML)
   Server-side infrastructure for performance increase
Services:
   Operations, Logistics and ring-fenced storage
   CHD$ Order Book Management

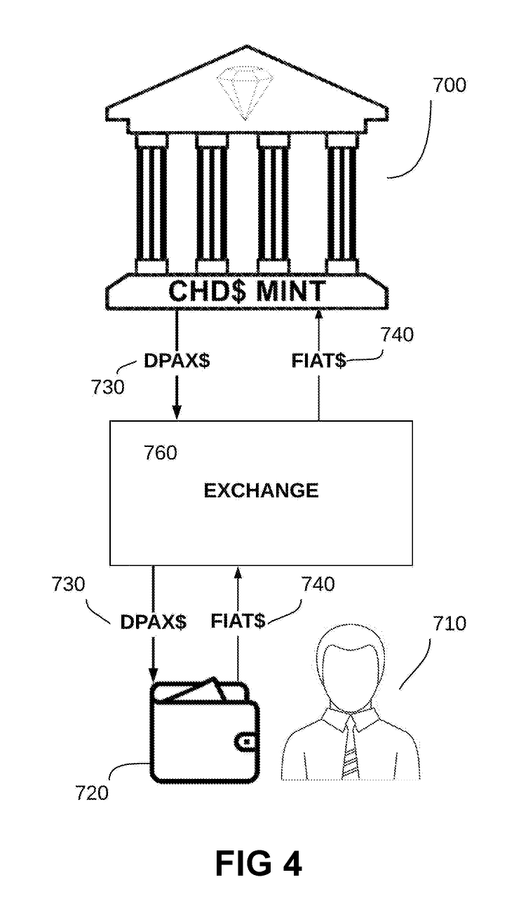

Referring to FIG. 4 both ABCP usage and governance is decentralized by design. In a contemplated implementation, the operations of the Mint 700 and ABCP are funded through the issuance of a utility cryptocurrency token 730 denominated in diamond platform access currency units (DPAX$) issued by the mint 700. It is contemplated that DPAX$730 will be created and issued by the mint 700 using an Ethereum smart contract and that DPAX$730 would be ERC20 (Ethereum Request for Comment 20) compliant for free exchangeability.

It is contemplated in a preferred implementation that there would be a one-hundred and fifty million maximum value for DPAX$ unit denominated currency objects 730 created by the mint 700, with an initial creation of DPAX$730 having a value of one-hundred and twenty million DPAX$730. Of this initial one-hundred and twenty million DPAX$730 it is contemplated that ninety million DPAX$730 would be sold by the mint 700 on an exchange 760 to raise fiat legal tender currency proceeds 740 to fund mint 700 operations. The remaining 30 million DPAX$730 would serve to foster the ecosystem for the mint's diamond based currency and allow for building critical mass for such currency. For example, if there is a large over the counter (OTC) buyer of the mint's diamond based currency on the one side, and a large diamond supplier on the other, these thirty million DPAX$730 could serve to help enable the trade without totally distorting the DPAX$730 market, thus avoiding excessive volatility spikes.

The additional thirty million DPAX$730 remaining after the initial one-hundred and twenty million issued could be created over time in order to support mint platform growth and avoid a congestion of the CHD$20 market. After creation, it is contemplated these additional thirty million DPAX$730 could not be sold directly, thus avoiding a DPAX$730 liquidity surplus in the market. These additional thirty million DPAX$730 could also serve to incentivize developers to participate building the mint platform ecosystem.

A mint DPAX$730 token is contemplated to be an Ethereum blockchain digital token that would be classified as a utility token pursuant to the FMA (Finanzmarktaufsicht) in Liechtenstein where the SwissDiamondCoin Foundation resides. A utility token is a token which is intended to provide access digitally to an application or service by means of a blockchain-based infrastructure. Mint DPAX$ 730 tokens satisfy this definition because they are intrinsically linked to the functionality of mint operations:
Suppliers of diamonds wishing to deposit them with the mint must onboard and pay a fee to the mint in the form of DPAX$730. In the exemplary embodiment of the system there is at least one authorizing operating instruction 630 in storage memory 40 that enforces this condition as a predefined condition precedent which must be satisfied before the system will execute a supply change operating instruction 630 in storage memory 40 to cause the minting of new currency objects for a diamond instance 30.
The mint can adjust the amount levied in DPAX$730 from diamond suppliers to cover mint costs and optimize mint operations. When doing so, the mint is bound by the mandates of its charter to always act in favor of the CHD$20 currency ecosystem.
There is no DPAX$730 token charge for buyers and sellers of CHD$20 based currency, because such a charge would be to the detriment of the CHD$ 20 currency ecosystem.
Over time, the mint will use the fiat legal tender funds 740 received by its sale of DPAX$730 on the one hand, but on the other will accumulate DPAX$730 again (in the form of fee payments from diamond depositors). This will allow the mint to periodically re-sell DPAX$730 and thus stay liquid.
DPAX$730 may be used to help regulate the purchase and sale of CHD$20: If two diamond suppliers offer to sell CHD$20 they received for their diamonds at the same fiat legal tender price, their orders would get filled in proportion to their DPAX$730 holdings.
DPAX$730 tokens are also contemplated to be required for the mint governance functions:
   Voting in matters of mint platform design and evolution
   Appointment of certain mint personnel

ABCP governance is set up to create a balance between both CHD$20 holders and the holders of DPAX$730 cryptocurrency tokens issued by the mint 700, and to allow a sustainable evolution of the ABCP over time. The mint acts as enabler and ensures that in a situation of system attack, emergency action can be taken.

The ABCP Protocol consists of Solidity source coded smart contracts 910 on the Ethereum blockchain 900. These smart contracts 910 define the core functionality of the ABCP. The design philosophy of the ABCP Protocol closely follows the approach postulated by Elena Dimitrova and Jack duRose from colony.io in their seminal article series on the topic of smart contract upgrading, smart contract robustness, and the implementation of token weighted voting.

Under the contemplated ABCP the CHD$ smart contracts (CHD$−CBCC) 910 include the logic and functionality for users to
Buy and sell CHD$
Transfer and hold CHD$, and to
Get delivery of diamonds for CHD$

The smart contracts also ensure checks and balances to maximize security of the CHD$ users: They ensure that the actions of independent third-parties in the value chain (examples: Gemological Institute of America (GIA) for grading, IIDGR (De Beers) for diamond inspection) are reflected on the blockchain.

The governance smart contracts transparently coordinate the following procedures:
Orchestration of ABCP functionality upgrades
Appointment of a CHD$ order book manager

In the exemplary embodiment there is contemplated to be a CHD$ mobile app that can be an interface between a user and the CHD$ system, including allowing a user to interact with the CHD$ smart contracts. The contemplated mobile app will be available for both Android and iPhone.

To perform KYC duties, it is contemplated that ABCP will use uPort in the form of an app-in-mobile app service, as well as the services of other dedicated service providers that offer Ethereum address certification. uPort is a decentralized digital ID wallet that stores the ID of the user with all its attributes on the mobile phone of the user. The root ID of the user is registered on the blockchain and linked to the digital wallet. A social recovery mechanism ensures that users who lose the private keys of their digital wallet can recover them. Authorities can attest the attributes of the user after having performed the necessary verifications. The integrated usage of uPort allows the ABCP to comply with KYC regulations, without the need to store user data on its premises or under its control. In a preferred implementation the ABCP would use a light wallet setup.

The coordination of the ABCP is performed by the mint which is specifically created for this purpose. The mint has the following roles:
Ensuring a smooth and productive collaboration of all service providers on the platform
Ensuring that all service providers fulfill their functional roles
Development of ABCP
Maintenance and enhancement of ABCP components
ABCP daily operations
Ensuring diamond quality and secure storage.

A Primary CHD$ Order Book Manager (“POBM”) is elected by the mint and the holders of DPAX$ cryptocurrency units. The POBM contributes to fostering the CHD$ ecosystem by balancing CHD$ demand on the one side, and newly created CHD$ by the Mint on the other. Specifically, via order book, the POBM:
Orchestrates, where possible, that diamond suppliers who bought CHD$ from the mint have counterparties to sell these CHD$ to for fiat legal tender currencies or other cryptocurrencies
Orchestrates, where possible, that potential CHD$ buyers can purchase CHD$ against fiat legal tender currencies or other cryptocurrencies

Furthermore, the POBM supports the mint in the attempt to ensure CHD$ liquidity in the secondary (retail) market. Note that CHD$ may be listed on major cryptocurrency exchanges as well, which will further improve market liquidity. Finally, the POBM is also mandated by the mint to contribute to dampening the volatility of CHD$, to the extent possible, through various currency policy actions.

For the credibility of ABCP, it is crucial the contemplated mint work with excellent third-party service providers in the industry. Every step in the value chain is contemplated to be ring-fenced from the next. Possible collaboration partners that may fulfill the quality standards of ABCP are Spacecode for diamond tracking, GIA for provenance and grading, Malca Amit for transport, De Beers for inspection, one of the Big Four accounting firms (Ernst & Young, Deloitte & Touche, KPMG and PricewaterhouseCoopers) for diamond audits, Lloyds of London for insurance, and Freeport Geneva or Swiss Reserve for diamond storage.

The Governance structure of ABCP is designed to protect it from 3 attack vectors: Collusion, moral factors, and external pressure. Governance adheres to the following principles:
Governance is decentralized and follows an objective system of checks and balances.
Governance rules are formulated as smart contracts in the ABCP Protocol. The Ethereum Blockchain ensures that there is no unilateral modification of these rules possible
There are two parties with voting rights:
   DPAX$ holders
   The mint

Voting by protocol can have two subjects: Protocol modification and the appointment of ABCP service providers.

### Voting on ABCP Protocol Modifications

DPAX$ holders can suggest a modification of the ABCP Protocol if they gather support of at least 5% of DPAX$ for such a proposal.
The mint can suggest a modification of the ABCP Protocol at any time.
Modifications are accepted if the mint plus the majority of the participating DPAX$ holders agree.
Votes will be announced a minimum of 20 days in advance via smart contract event, and via push notification to the mobile app, and notified about the outcome in the same way.
Emergency votes can be held when mint ask for such a vote in case of attack scenarios. The possibility of emergency voting exists to counter possible attacks of malicious parties to the detriment of CHD$ and/or DPAX$ holders

### Voting on CHD Primary Order Book Manager

The mint can periodically suggest a POBM.
The proposal to replace the POBM is accepted if both the majority of the participating DPAX$ holders and the mint agree.
Votes will be announced 20 days in advance via smart contract event, and via push notification to the mobile app, and notified about the outcome in the same way.

### Mint Charter Mandates Regarding Diamond Assets

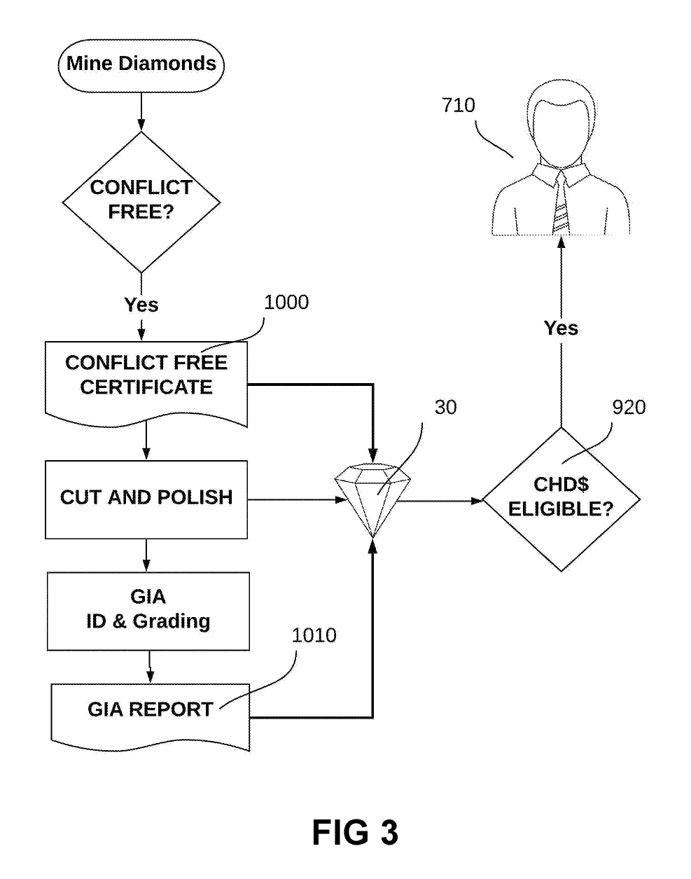

In the exemplary system it is contemplated that the governing charter of the mint imposes legal obligations upon it in the jurisdictions of its operations regarding the mint's acquisition, storage and distribution of diamonds that are used as base assets for CHD$. Referring to FIGS. 1 and 3 by way of example, the mint charter may require that all diamonds acquired by the mint for use as base assets of CHD$ a) have a Kimberley Certificate to ensures that no “conflict-diamonds” enter the system (i.e. no “blood diamonds”) 1000; b) have their physical attributes independently graded and certified by the Gemological Institute of America (GIA) or other organization 1010; c) be stored in a high-security facility such as a secured vault, the Geneva freeport, etc. 750; d) have their inventory at the Mint regularly audited and verified, and e) be fully insured. Additionally, in the exemplary implementation the mint charter mandates that only diamonds having the following high-quality physical attributes 1020 are eligible to be accepted for deposit as base asset instances of CHD$:
Colors from D to K
Clarity from IF to VS2
Carat from 0.3 to 5
Cut grades of Very good or Excellent.

In the exemplary embodiment of the system there is at least one authorizing operating instruction 630 in storage memory 40 that enforces the requirements that a diamond instance deposited be certified as to conflict-free source, certified as to their physical attribute values, satisfy the above deposit eligibility criteria for physical attributes, be physically secured by system owner, and be fully insured, as predefined condition precedents 920 that must be satisfied before the system will execute a supply change operating instruction 630 in storage memory 40 that will cause the minting of new currency objects based on such diamond instance 30.

### Diamond Acquisition

Referring to FIG. 9 in the exemplary system CHD$ is a cryptocurrency that is based on high-quality diamonds 30. CHD$ is created on, and transacted via, the Ethereum blockchain 900 under a smart contract (CHD$−CBCC) 910 that is owned and controlled exclusively by the mint 700. CHD$ tokens 20 that exist under the CHD$−CBCC 910 comply with the ERC20 standard for interoperability and are also contemplated to comply with the proposed ERC621 standard for regulating the amount of a cryptocurrency in existence. CHD$ transactions in the exemplary implementation are free of charge, apart from the inherent Ethereum fees (ETH gas).

Under the CHD$−CBCC 910 which is guaranteed by the Ethereum blockchain 900, there can never be more CHD$ in the system than the value of the diamond instances 30 the CHD$ are based on. As exclusive owner of the CHD$−CBCC 910 only the mint 700 may give an owner authorization that is able to trigger CHD$ creation under the CHD$−CBCC 910 smart contract. In the exemplary embodiment of the system there is at least one authorizing operating instruction 630 in storage memory 40 that enforces this owner authorization condition as a predefined condition precedent 920 that must be satisfied before the system will execute a supply change operating instruction 630 in storage memory 40 that will cause the minting of new currency objects for a diamond instance 30. In this way the mint using the system of the present invention can ensure that an owner of CHD$ can always get delivery of a diamond from the mint in exchange for a sufficient amount of CHD$.

### Mint Diamond Asset Identification

In the exemplary system it is contemplated that the diamond ID created by the GIA grading authority for any diamond acquired by the mint will be stored on the Ethereum blockchain as predefined condition precedent to execution of a supply change operating instruction. This helps to ensure that no other diamond can bear the same ID (counterfeit protection).

### Mint Diamond Asset Selection

From the total supply of available diamonds, the highest-quality diamonds that can be freely traded are selected by the mint. In the contemplated exemplary embodiment, the eligible diamond color values range from D to K, the eligible clarity values range from IF to VS2, and the eligible carat weights range from 0.5 to 5. Furthermore, only a very good or excellent grade of cut is allowed. Additional filters for symmetry, polish, fluorescence and proportions may also be applied.

### Mint Diamond Asset Transport:

It is contemplated that only specialized “High Value Logistics” companies would be employed by the Mint to transport diamonds used as base assets to their safe storage vaults, such as the Geneva freeport facility in Switzerland.

### Mint Diamond Asset Inspection

It is contemplated that an established diamond inspection company (e.g., IIDGR—International Institute of Diamond Grading & Research—part of the De Beers Group of Companies), would inspect all diamonds when they are delivered to storage.

### Mint Diamond Asset Storage:

It is contemplated that only selected high security storage providers would be used as storage vaults for the diamonds, such as the Geneva freeport in Switzerland.

### Mint Diamond Asset Stock Verification:

It is contemplated that a notary will verify the existence of the diamond stock, and an independent auditor will perform an inventory audit on a regular basis.

### Diamond Insurance:

It is contemplated that an insurance consortium will provide coverage in case of diamond theft or diamond loss by a storage vault provider, or during transport.

### Determining a Total Denomination Value for a Diamond Instance

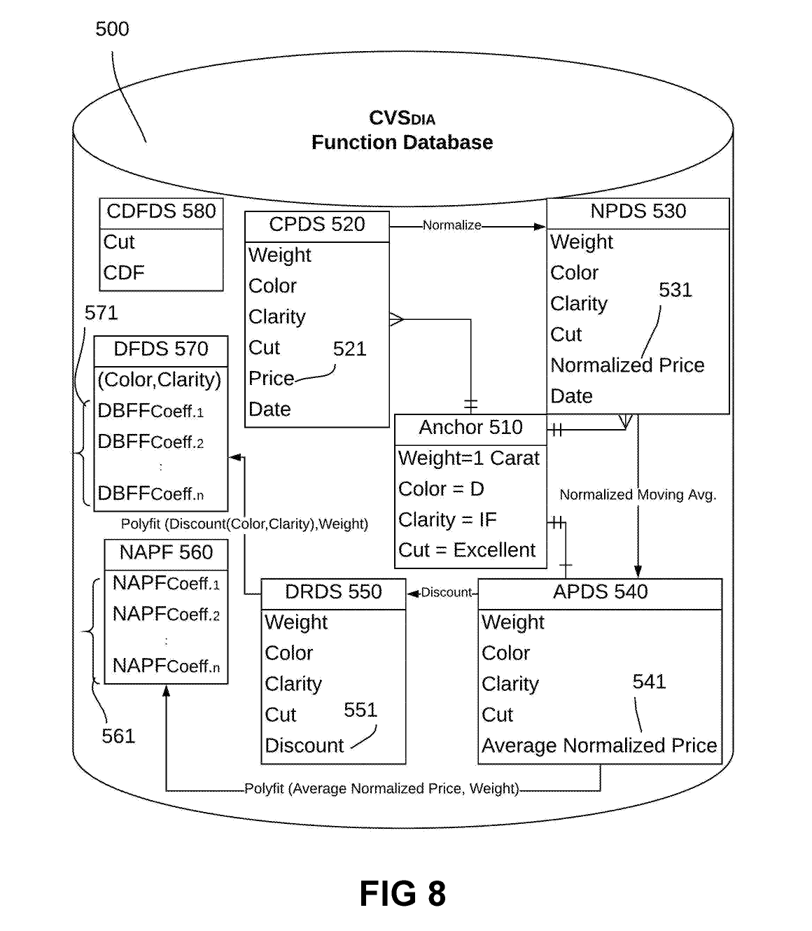

Referring to FIG. 8, the ABCP using the system of the present invention would use a CVS Function Database 500 to calculate the total denomination value in CHD$ for currency objects to be created for each diamond instance acquired by the mint and used as a base asset for CHD$.

### The CVS Function Database for Diamonds

### Defining the Anchor Object 510 for A Diamond

The CVS Function Database 500 of the system of the present invention using diamonds has an anchor object 510 defining the physical attribute values for an anchor instance diamond. The anchor instance diamond has reference physical attributes against which the relative value of diamonds with different physical attributes will be determined. In an exemplary embodiment of the present invention the anchor instance definition for a diamond is an internally flawless colorless round diamond of a particular weight in carats. Specifically, in the exemplary implementation the anchor object is a round diamond having a weight of 1 carat (0.2 g), a GIA color grade of D (colorless) and a GIA clarity grade of IF (internally flawless—no inclusions), and a GIA cut grade of excellent.

### The CIT Price Data Set (CPDS) Object 520 for Diamonds

The CVS Function Database 500 of the system of the present invention using diamonds has a CPDS object 520 for diamonds that contains a plurality of records for the market prices of diamonds. For diamonds the data of the CPDS object 520 may be readily obtained from “Rapaport Diamond Reports”. Rapaport diamond prices are widely accepted as the price reference in the diamond market. The reports are issued weekly and use the GIA grading characteristics “Carat, Color, Clarity” as variables of price. Rapaport also distinguishes between round and fancy shapes and issues separate reports for each. In the exemplary system the CPDS 520 is populated with the data from the Rapaport Diamond Reports for a period of ten years.

In the exemplary illustrated system the CPDS object 520 has record structure with a date value field, a carat value field, a color value field, a clarity value, a cut value field, and a price value field 521. The carat value is the PIPA value for diamonds. The combination of color and clarity for a diamond are the DIPA values φ. The cut field value of a diamond is the CPA value co. In the exemplary system, for purposes of illustration only, the CPDS object 520 has ten different date field values, with the time period interval between date field values being equal to one year.

Records in the CPDS object 520 that have the same date field value define a time period subset of records CPDS_{TP}. Accordingly, in the exemplary implementation there are ten time period subsets of price records. Every price record in a CPDS_{TP} subset has a unique combination ϕ of carat, color, clarity, and cut values. All CPDS_{TP} subsets have the same number of price records with the same corresponding unique combination ϕ of carat, color, clarity and cut values. CPDS=Σₙ₌₁¹⁰{CPDS_{TP}}ₙ.

### The Normalized Price Data Set (NPDS) Object 530 for Diamonds

The CVS Function Database 500 of the system of the present invention using diamonds has an NPDS object 530 derived from the records of the diamonds in the CPDS object in accordance with Formula 9. Each individual price record CPDS_{X}_{_{TP}} from a subset CPDS_{TP} is copied into the NPDS object as a normalized price record NPDS_{X}_{_{TP}}. The value of the normalized price field (NPDS_{X}_{_{TP}}: Normalized Price) 531 for each record NPDS_{X}_{_{TP}} in the NPDS object 530 is calculated to equal to the price field value (CPDS_{X}_{_{TP}}: Price) 521 of the corresponding record CPDS_{X}_{_{TP}} in CPDS_{TP} divided by the price field value (CPDS_{AN}_{_{TP}}: Price) 521 of the anchor instance record CPDS_{AN}_{_{TP}} in CPDS_{TP}. As shown in Formula 9 the anchor instance record CPDS_{AN}_{_{TP}} in CPDS_{TP} is the record in CPDS_{TP} that has the same carat, color, clarity and cut values as the anchor object:

NPDSₓ_{_{TP}}:Price=(CPDS_{X}_{_{TP}}:Price)/(CPDS_{AN}_{_{TP}}:Price)

CPDS_{AN}_{_{TP}}={CPDS_{TP}|CPDS:PIPA_{X}_{_{TP}}=1carat∧CPDSφ_{X}_{_{TP}}=D,IF∧CPDSω_{X}_{_{TP}}=Excellent} Formula 9

### The Average Price Data Set (APDS) Object 540 for Diamonds

The exemplary system has a data object APDS 540 in the CVS Function Database 500. Each record in the APDS object 540 has a field for a PIPA value (carats), fields for DIPAφ (color and clarity) values, a field for CPAω (cut) value, and a field for average normalized price. The records of the APDS are derived from the records of the NPDS. More specifically, each record in the APDS is derived from a set of records PA_{ϕ} that is a subset of the NPDS records.

A PA_{ϕ} record subset in the NPDS consist of all records in the NPDS which have the same ϕ combination of carat, color, clarity, and cut values. In other words, the records in the NPDS across all time periods in the NPDS that have the same values for carat, color, clarity and cut are the records in a set PA_{ϕ}.

For each ϕ combination of carat, color, clarity and cut there is an APDS_{ϕ} record having the same ϕ combination of physical attribute values. As shown in Formula 10 below the value of the average normalized price field (APDS_{ϕ}: Price) for each APDS_{ϕ} record in the APDS is equal to the average of the normalized price field values for the PA_{ϕ} records as determined by the solution of an Average Function (AF):

APDS_{ϕ}:Price=AF({PA_{ϕ}:Price}) Formula 10

In a preferred embodiment of the system of the present invention the AF used calculates the exponential weighted moving average for the price field values in PAϕ for the number of time periods in PAϕ. Other types of AF however may also be used with the invention.

### The Discount Rate Data Set (DRDS) Object 550 for Diamonds

In the exemplary system there is a data object DRDS 550 in the CVS Function Database 550. Each record of DRDS 550 is derived from the records of the APDS object 540. Specifically, each individual record APDS_{X} is copied into DRDS 550 as a corresponding record DRDS_{X}. The value of the discount field (DRDS_{X}: Discount) for each record DRDS_{X} in DRDS 550 is calculated to be equal to ratio of the APDS_{X}:Average Normalized Price value 541 to the APDS_{AN}:Average Normalized Price value 541, where APDS_{AN} is the record in APDS that has the same physical attribute values as the anchor object.

As shown in Formula 11 the anchor instance record APDS_{AN} in APDS is the record APDS_{X} in APDS such that PIPA_{X}=1 and DIPA_{φX}=IF,D and CPA_{ωX}=cut:

DRDS_{ϕ}:Discount=(APDSϕ:Price)/(APDS_{AN}:Price)

APDS_{AN}={APDS|PIPA_{X}=1∧DIPAφ_{X}=IF,D∧CPAω_{X}=cut} Formula 11

### The Normalized Average Price Function (NAPF) Object 560 for Diamonds

In the exemplary system a data object NAPF 560 is in the CVS Function Database 500. The NAPF 560 holds the coefficient and constant values 561 for the normalized average price function [NAPF_{CIT}(PIPA)]. NAPF_{CIT}(PIPA) models the relationship between the average normalized price field values 541 and PIPA values in APDS 540. The coefficient and constant values for NAPF_{CIT}(PIPA) starts with a polynomial regression analysis performed on the normalized average price field values and PIPA values in APDS. The result of this polynomial regression analysis is a best fit polynomial function of APF(PIPA) as shown in Formula 12.

APF(PIPA)=Polyfit APDS(Price,PIPA) Formula 12
Polyfit APDS(Price, PIPA)=A polynomial function that is derived from a polynomial regression analysis of the relationship between the average normalized price field values and PIPA field values in APDS.

In the exemplary embodiment it is contemplated that the regression analysis for diamonds would be for a second-degree polynomial, and would produce the coefficients for a quadratic APF for diamond weight as follows:

APF(Carats)=a(Carats)²+b(Carats)+c

For purposes of illustration only, and not limitation, exemplary values of coefficients for the above quadratic APF may be a=100,000; b=25,000; c=40,000:

APF(Carats)=100,000(Carats)²+25,000(Carats)+40,000

The acquisition of the values for NAPF_{CIT}(PIPA) is completed as shown in Formula 13 below by normalizing the APF(PIPA) such that its solution for PIPA_{AN} of the defined anchor object will always be a specific number (CurrencyUnits_{AN}):

NAPF(Carats_{IN})=AP(Carats_{IN})*[Currency_{AN}/AP(1)]

NAPF(Carats_{IN})=AP(Carats_{IN})*[1000/AP(1)]

NAPF(Carats_{IN})=606.1(Carats)²+151.5(Carats)+242.4 Formula 13

In the exemplary implementation the specific value of Currency_{AN} chosen, for illustration purposes only, is one thousand (1000). In the exemplary system the coefficient and constant values 561 for the above quadratic polynomial equation are stored in NAPF 560 of the CVS Function Database 500.

### The Discount Function Data Set (DFDS) Object 570 for Diamonds

In the exemplary system a data object DFDS 570 is in the CVS Function Database 500. Each record of DFDS 570 is derived from the records of DRDS 550 and contains the coefficient and constant values 571 for the discount bet fit function (DBFFφ) of an instance of diamond having a particular combination of color and clarity (DIPAφ). Accordingly, each record in DFDS has fields with the DIPA values of color and clarity, and one or more fields for the coefficient and constant values 571 of the DBFF_{φ}.

The DBFFφ values 571 of each record in DFDS 570 are derived from a subset of records DR_{φ} in DRDS 550 records. Specifically, the DR_{φ} record subset of DRDS 550 consists of all records in DRDS 550 which have the φ combination of color and clarity. For each DR_{φ} set of records that exists in DRDS 550 there is one corresponding record in DFDS 570 that has the value of its color and clarity fields equal to the combination φ.

The values for DBFFφ of each record in DFDS 570 are the coefficients of the function that best models the relationship between the discount field values and PIPA field values for the DR_{φ} record subset in DRDS: In a preferred method of obtaining these coefficient values of DBFFφ for a particular φ combination of color and clarity values a polynomial regression analysis is done of the discount field values and PIPA field values for the DR_{φ} set of records.

DBFFφ(PIPA)=Polyfit DRφ(Discount,PIPA) Formula 14
Polyfit DRφ(Discount, PIPA)=A polynomial function that is derived from a polynomial regression analysis of the relationship between color and clarity combination values and the PIPA values of the DR_{φ} record subset in DRDS.

The resulting DBFFφ function will take as its input the carat value of an instance of a diamond that has the φ combination of color and clarity. The solution of the DBFFφ for such instance of diamond having φ combination of color and clarity values and a PIPA value will be a discount rate factor (DRFφ) with a value between zero and one: 0≤DRFφ≤1.

### The Conditional Discount Factor Data Set (CDFDS) Object 580 for Diamonds

In the exemplary system there is a data object CDFDS 580 in the CVS Function Database 500. Each record of the CDFDS 580 has a field for the cut value of a diamond instance (CPAω), and also field for an associated conditional discount factor (CDF) value. The CDF values for diamonds based on cut are based on the opinions of diamond experts regarding the effect on price a particular cut value has. In the contemplated exemplary embodiment 0≤CDF_{cut}≤1.

### Using the CVS Function Database to Compute Total Denomination Value

In the exemplary system the physical attribute values for a diamond instance is obtained from the certified GIA grading report for the diamond instance. The total denomination value 660 in currency units for a diamond instance is the CVS function CVS_{CIT}(IN) as shown in Formula 15:

CVS_{DIA}(IN)=NAPF_{DIA}(Carats_{IN})*[DBFF_{DIA}(Color_{IN},Clarity_{IN})o(Carats_{IN})]*CDF_{DIA}(Cut) Formula 15
DIA=Diamond
IN=Evaluated instance of diamond
NAPF_{DIA}=Normalized average price function for diamond
Carats_{IN}=Carat value for evaluated diamond instance
Color_{IN}=Color value for evaluated diamond instance
Clarity_{IN}=Clarity value for evaluated diamond instance
DBFF_{DIA}(Color_{IN},Clarity_{IN})=DBFF of a diamond with Color_{IN} and Clarity_{IN}
Cut=Cut value for evaluated diamond instance
CDF_{CIT}(ω)=CDF value for the CIT with CPA values=ω.

The user of the exemplary system of the present invention uses an input mechanism 110 of computing system 60 to store a weight value primary input value) 600, a color value (discount input value) 610, a clarity value (discount input value) 610 and a cut value (conditional input value) 620. At least one operating instruction 630 in the storage memory 40 is executed by a processor 50 of the computing system 60 to receive and store these input values in storage memory 40.

Processor 50 then executes at least one operating instruction in memory 40 to retrieve values from the CVS Function Database 500 for the components of CVS_{DIA}(IN). Specifically, the coefficient and constant values 561 for the first component value function NAPF_{DIA}; the associated coefficient and constant values 571 of DBFF_{DIA}(Color_{IN},Clarity_{IN}) and the value of CDF_{DIA}(Cut). For purposes of illustration only a calculation of a hypothetical instance diamond is shown below in Formula 16:

CVS_{DIA}(IN)=NAPF_{DIA}(Carats_{IN})*[DBFF_{DIA}(Color_{IN},Clarity_{IN})o(Carats_{IN})]*CDF_{DIA}(Cut) Formula 16
DIA=Diamond
IN=Evaluated instance of diamond
NAPF_{DIA}=606.1(Carats)²+151.5(Carats)+242.4=3212.2
Carats_{IN}=2
Color_{IN}=F
Clarity_{IN}=VVS₂
DBFF_{DIA}(Color_{IN},Clarity_{IN})=0.01(Carat)2+0.1(Carat)+0.2=0.64
Cut=Very Good
CDF_{CIT}(ω)=0.75
CVS_{DIA}(IN)=3212.2*0.64*0.75
CVS_{DIA}(IN)=1541.856 CHD$

### Creating and Using Diamond-Based CHD$ Currency

In the exemplary system either before or after a total denomination value in CHD$ currency units is determined for an instance of a diamond the system will execute at least one authorizing operating instruction to check that all predefined conditions precedent for executing a supply change operating instruction have been satisfied. If all predefined conditions precedent have been satisfied, then the system will execute at least one supply change operating instruction in storage memory to change the total supply value of CHD$ currency in the CHD$−CBCC Ethereum blockchain contract. The user of the system may then transfer to the cryptocurrency wallet of the diamond instance depositor the total denomination value of CHD$ calculated diamond instance deposited. The entire transaction will be recorded in the Ethereum blockchain.

The depositor of the diamond instance and recipient of the newly issued $CHD may use the currency in Ethereum block chain transactions with anyone who will accept CHD$ as payment for goods, services, or repayment of debts. Any holder of CHD$ may exchange the value of their CHD$ for real diamonds from the mint, at which time such CHD$ cryptocurrency tokens would be removed (i.e. burned) from the CHD$−CBCC by the mint. The owner of CHD$ can pick and choose any diamond in possession and storage of the mint for delivery, as long as such owner has enough CHD$ cryptocurrency tokens. There is no right in the exemplary embodiment for an owner of CHD$ to get delivery of a specific diamond from the mint—the principle of “first come, first serve” applies.

1. A system for determining a total denomination value for one or more currency objects that is representative of the physical attributes of a commodity item type instance comprising:
a computing system having a processor with access to a storage memory, an input mechanism, and an output mechanism;
a commodity value scale function database located in said storage memory;
said commodity value scale function database having:
a normalized average price function data object that has a record structure with one or more fields for storing coefficient values of a normalized average price function that uses a primary intrinsic physical attribute value for a commodity item type as a function input;
a discount factor data set object with a record structure that includes one or fields for storing identifying discount intrinsic physical attribute values for said commodity item type and one or more fields for storing coefficient values of a discount best fit function that uses said primary intrinsic physical attribute value as a function input;
at least one operating instruction in said storage memory for receiving into said storage memory from the input mechanism a primary input value for said primary intrinsic physical attribute value of an instance of said commodity item type;
at least one operating instruction in said storage memory for receiving in said storage memory through said input mechanism one or more discount input values for said discount intrinsic physical attribute values of said instance;
at least one operating instruction in said storage memory for determining a first component value that is the solution of said normalized average price function using said primary input value;
at least operating instruction in said storage memory for using said one or more discount input values to select from said discount factor data set object an instance discount best fit function;
at least one operating instruction in said storage memory for said processor to determine a second component value that is the solution of said instance discount best fit function using said primary input value;
at least one operating instruction in said storage memory for setting a total denomination value as a calculated product of said first component value and said second component value; and
at least one operating instruction in said storage memory for communicating said total denomination value to said output mechanism.

2. The system of claim 1 further comprising:
a conditional discount factor data set object in said commodity value scale function database that that has a record structure which includes one or more fields for storing identifying conditional physical attribute values for said commodity item type and a field for a conditional discount factor;
at least one operating instruction in said storage memory for receiving in said storage memory through said input mechanism one or more conditional input values for said conditional physical attribute values of said instance;
at least one operating instruction in said storage memory for using said conditional input values to select from said conditional discount factor data set object a conditional discount factor value; and
where said at least one operating instruction in storage memory for setting a total denomination value sets the total denomination value as a calculated product of said first component value and said second component value and said selected conditional discount factor value.

3. The system of claim 1 further comprising at least one supply change operating instruction in said storage memory for changing a total currency supply value of a blockchain network commodity-based currency contract by an amount equal to said total denomination value.

4. The system of claim 3 further comprising at least one authorizing operating instruction of said commodity-based currency contract requiring satisfaction of a predetermined condition precedent prior to execution of said at least one supply change operating instruction.

5. The system of claim 4 where said predetermined condition precedent is an authorization of an owner of said commodity-based currency contract.

6. The system of claim 4 where said predetermined condition precedent is a certification of said primary input value and said one or more discount input values for said instance of said commodity item type.

7. The system of claim 4 where said predetermined condition precedent is a determination that said primary input value and said one or more discount input values for said instance of said commodity item type satisfy attribute eligibility conditions.

8. The system of claim 4 where said predetermined condition precedent is a certification that said instance of said commodity item type is physically secured by an owner of said commodity-based currency contract.

9. The system of claim 4 where said predetermined condition precedent is a certification that said instance of said commodity item type is insured.

10. The system of claim 4 where said predetermined condition precedent is a certification as to the source of said instance of said commodity item type.

11. The system of claim 4 where said predetermined condition precedent is evidence of a fee payment to an owner of said commodity-based currency contract.

12. The system of claim 11 where said fee payment must be in the form of a utility currency object issued by said owner.
